(19) United States
(12) Patent Application Publication
(10) Pub. No.: US 2008/0266849 A1
(43) Pub. Date: Oct. 30, 2008

(54) FLUORESCENT LIGHTING CONVERSION TO LED LIGHTING USING A POWER CONVERTER

(76) Inventors: Lyman O. Nielson, Williams, AZ (US); Anthony A. Mangiaracina, Mobile, AL (US)

Correspondence Address: MADSON & AUSTIN, 15 WEST SOUTH TEMPLE, SUITE 900, SALT LAKE CITY, UT, 84101, US

(21) Appl. No.: 12/112,199

(22) Filed: Apr. 30, 2008

Related U.S. Application Data
(60) Provisional application No. 60/915,005, filed on Apr. 30, 2007.
(60) Provisional application No. 60/915,617, filed on May 2, 2007.

(51) Int. Cl. F21V 23/02

(52) U.S. Cl. 362/221

(57) ABSTRACT

A power converter is added to a fluorescent light to inexpensively convert fluorescent lighting to LED lighting utilizing existing ballast technology. This will encourage and facilitate conversion to more efficient lighting and the result will be energy savings. The conversion is relatively inexpensive and easy to do vs. fixture replacement. Two factors, which will encourage conversion to more efficient lighting are cost of conversion and time of conversion. The power converter will make it economically viable to convert to LED lighting.

### CROSS-REFERENCED RELATED APPLICATIONS

This application claims the benefit of U.S. Provisional Application No. 60/915,005, filed Apr. 30, 2007. This application also claims the benefit of U.S. Provisional Application No. 60/915,617, filed May 2, 2007. Both of these application are expressly incorporated herein by reference.

### BACKGROUND OF THE INVENTION

1. The Field of the Invention

The present invention relates to systems for lighting an area using energy-efficient light emitting diodes (“LEDs”). More specifically, the present invention relates to systems and methods for replacing existing fluorescent lighting system with new systems that use energy-efficient LEDs.

2. The Relevant Technology

For about one hundred years, electric lights and lighting systems have been routinely used in buildings, offices, and residences. In fact, building safety codes now mandate that lights and lighting systems be part of the building. Thus, any commercial or residential building presently used in the United States should have some type of lights or lighting systems.

One of the most widely and commonly used light fixtures in both commercial buildings and residential buildings are the so-called fluorescent lights. Fluorescent lights are generally long, thin cylinders that may be illuminated to provide lighting to a particular area, especially larger rooms or areas. In the United States, there are approximately 2,500,000,000 fluorescent fixtures in operation.

In commercial and industrial lighting sectors in the world, fluorescent lights are the most common source for lighting. Lighting systems for commercial and industrial property consume 65% of all power used for lighting in the United States. For commercial and industrial lighting needs, fluorescent lighting is used as the primary lighting source to illuminate these commercial/industrial buildings. It is estimated that there are approximately 1,600,000,000 fluorescent fixtures used in commercial/industrial buildings. These fluorescent lights are generally a T12 type fluorescent light fixture or a T8 type fluorescent light fixture. Both T12 and T8 lights are commercially available through almost all vendors of lighting.

At the same time, many people are becoming increasingly concerned about the amount of energy consumption in the United States and throughout the world. It is for this reason that many governmental agencies and individuals have become concerned with finding more energy-efficient lighting systems that will consume less power (electricity) during operation. The overall goal of such research is to use electrical power more efficiently.

Such needs for more energy-efficient lighting has led the United States Department of Energy (“USDOE”) to focus on LEDs and LED technology. This focus has resulted in improvements in LED lights and LED technology. Such improvements continue to be developed at a rapid pace. LEDs and LED devices are sometimes referred to as “Solid State Lighting” or “SSL.” SSLs are known to be more energy-efficient than are fluorescent lights or other types of lights. The goal of this research and focus is to find ways by which SSLs (and more specifically LEDs) may replace less efficient lighting (such as incandescent and fluorescent lights).

To further foster research regarding SSLs, the USDOE has initiated a multi-year program to work with industry in the development of LED technology. In March, 2006, a report entitled “Solid-State Lighting Research and Development Portfolio” explains the USDOE's partnership with industry in promoting SSL research. (This report is expressly incorporated herein by reference.) On page 9 of this report it states that the USDOE is creating a focused partnership between government and industry, to accelerate SSL technology with the potential to reduce energy consumption, to create affordable long-lasting general illumination technology, to strengthen U.S. leadership in this critical technology area, and to provide necessary infrastructure (people and policy) to accelerate market adoption. Indicators of success would be two quads of energy per year displaced, a market price of $3 per kilolumen, and the creation of new forms of lighting systems that improve our quality of life. In other words, the purpose of the partnership between the USDOE and the lighting industry is to improve LED efficiency and to make the LED a viable replacement for fluorescent and incandescent lighting.

Accordingly, there is a need in the industry to find a mechanism by which less efficient fluorescent lights may be replaced with more efficient LEDs and LED-containing fixtures. Such a device and method for replacing fluorescent light fixtures is disclosed herein. Because LED light fixtures are less expensive to operate than are existing and new fluorescent fixtures, there is a tremendous economic incentive for a building owner to convert the fluorescent fixtures to more efficient LED fixtures. Accordingly, the present disclosure also teaches inexpensive methods for converting or retrofitting existing fluorescent lighting fixtures to more efficient LED lighting systems. This replacement of fluorescent lights with LEDs may be accomplished without requiring the building owner to replace/overhaul the existing lighting/electrical system.

### BRIEF SUMMARY OF THE INVENTION

The present embodiments relate to a lighting system that includes LEDs. This lighting system may be used to retro-fit/convert existing fluorescent light fixtures to fixtures that use LEDs.

A typical fluorescent light fixture includes a ballast. This ballast is used to light fluorescent lamps by modifying electrical voltage and frequency to designated levels that drive the fluorescent lamps. When a switch activates power, the 120/277 Voltage power travels to the ballast, the ballast converts the power to the designed power level so that the ballast activates the fluorescent lamps. This process is repeated day in and day out every time the switch turns on the power.

In order to convert the fluorescent light into a fixture that uses LEDs, an AC (alternating current) to DC (direct current) converter is used. This power converter may be positioned on the light fixture, such as within the ballast tray cover. Such incorporation of the power converter into the light fixture can be done relatively inexpensively versus the cost of replacing the entire light fixture/light system.

Once the power converter has been positioned, leads from the ballast, which would generally be connected to the lamp sockets for the fluorescent lamps, are instead connected to the power converter. As its name suggests, the power converter converts the AC power output by the ballast into LED power (which may be, for example, DC power). The power converter may convert any type of power (such as pulse DC power) into a form that is usable by the LED (although the conversion is typically from AC to DC power).

LEDs may then be added to the lighting fixture. These LEDs may be positioned as part of the light fixture such as on the illuminating surface of the light, on the light's ballast tray cover, or at other portions of the light. (In other embodiments, the LEDs may be positioned remote from the light fixture.) The DC power from the power converter could then be attached to the LEDs and used to drive the LED lamps.

The purpose of the power converter is to inexpensively convert fluorescent lighting to LED lighting utilizing existing ballast technology, i.e., it does not require a replacement of existing ballasts/light systems. This will encourage and facilitate conversion to more efficient lighting and the result will be energy savings. The conversion is relatively inexpensive and easy to do versus fixture replacement. Two factors, which will encourage conversion to more efficient lighting, are cost of conversion and time of conversion. The power converter will make it economically viable to convert to LED lighting.

### BRIEF DESCRIPTION OF THE SEVERAL VIEWS OF THE DRAWINGS

In order that the manner in which the above-recited and other features and advantages of the invention are obtained will be readily understood, a more particular description of the invention briefly described above will be rendered by reference to specific embodiments thereof which are illustrated in the appended drawing(s). Understanding that these drawing(s) depict only typical embodiments of the invention and are not therefore to be considered to be limiting of its scope, the invention will be described and explained with additional specificity and detail through the use of the accompanying drawing(s) in which:

FIG. 1 is a schematic view of an exemplar of a lighting system according to the present embodiments;

FIG. 2 is a schematic of a lighting system that includes a power converter;

FIG. 2A is a schematic of a lighting system that includes a power converter and

FIG. 3 is a schematic view of another embodiment of a lighting system that includes a power converter.

### DETAILED DESCRIPTION OF THE INVENTION

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, is not intended to limit the scope of the invention, as claimed, but is merely representative of presently preferred embodiments of the invention.

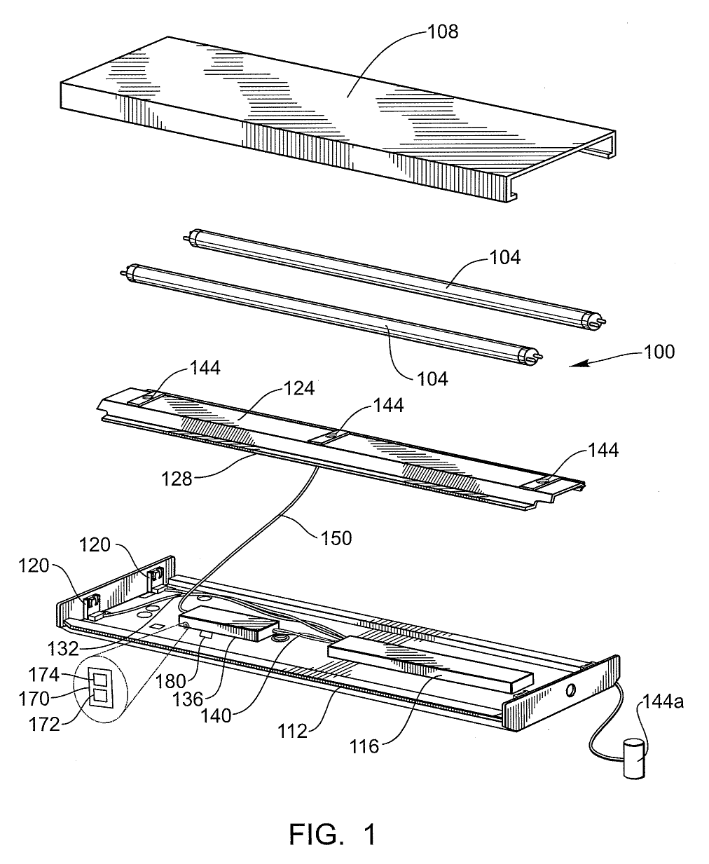

Referring now to FIG. 1, a light system 100 is illustrated. The light fixture 100 is a fluorescent light system that has been retro-fit and/or converted into a light emitting diode (“LED”) light system in accordance with the present embodiments. Prior to conversion into an LED lighting system, the light system 100 was a fluorescent light system. For this reason, FIG. 1 shows many components typically found in a fluorescent light. For example, FIG. 1 shows at least one fluorescent lamp 104 being used as part of the light 100. A cover 108 (sometimes called a lens) may optionally be present as part of the light fixture 100. As is known in the art, the cover 108 may be positioned over the lamps 104 and/or other portions of the light fixture, thereby making the overall visual appearance/decor of the light fixture 100 more appealing.

A ballast tray 112 is used as part of the light fixture 100. The ballast tray 112 is may be a housing for the wiring (i.e., a conduit) for the lighting system. Two or more sockets 120 (which are sometimes called “tombstones”) may also be used as part of the light fixture. As is known in the art, the fluorescent lamps 104 may be positioned to engage the sockets 120. A ballast 116 is also added to the fixture. As is known in the art, the ballast 116 contains the circuitry, wiring, electronics, and/or other elements necessary to operate the fluorescent lamps 104. Those skilled in the art will appreciate how the ballast 116 may be constructed. Some ballasts are also commercially available. As discussed above, the ballast 116 will typically be a T12 or T8 ballast. However, other types of ballasts may also be used.

A ballast cover 124 may also be added to the light fixture 100. (The ballast cover 124 is sometimes referred to as a “ballast tray cover”). The ballast cover 124 may be positioned over the ballast tray 112. The ballast cover 124 may be designed to cover the wiring and/or electrical components of the ballast tray 112 when the ballast cover 124 is properly positioned. Such masking of the electrical components of the ballast tray 112 will increase the overall decor of the light fixture 100. In some embodiments, the ballast cover 124 may have a ledge 128 that engages the ballast tray 112 and allows the ballast cover 124 to “snap into place.” Those skilled in the art will appreciate how this may be accomplished and will also understand other ways/mechanisms through which the ballast cover 124 may engage the ballast tray 1 12.

As explained above, one of the purposes of the present disclosure is to convert the light fixture 100 from a fluorescent light fixture into an LED light fixture. However, in order to understand how this conversion may occur, it is necessary to describe the operation of a fluorescent light system. In typical operation, AC power (or AC voltage) is provided from the building to the ballast 116. Leads 132 connect the sockets 120 with the ballast 116. Accordingly, when a switch activates power to the ballast 116, the AC power (which is typically-120/277 Voltage power) travels to the ballast 116, the ballast converts the power to the designed power required to activate the lamps 104. This power is then sent to the sockets 120 via the leads 132 so that the fluorescent lamps 104 become illuminated. When the switch is turned off, AC power is no longer supplied to the ballast 116 and, in turn, the lamps 104 turn off.

The way in which the light fixture 100 may be converted from a fluorescent light fixture into a light fixture that uses LEDs will now be described. Specifically, an alternating current to direct current converter 136 (power converter) has been added to the light fixture 100. This converter is a device that changes alternating current (AC) into direct current (DC). The converter 136 is designed to convert the power that would normally go from the ballast to the lamps. As is known in the art, in conventional fluorescent lights, the ballast provides the high voltage necessary to drive/illuminate the fluorescent lamps. Fluorescent lamps require a high voltage to excite the phosphorous in the fluorescent tubes. The voltage necessary to drive such lamps may often be much higher than the standard 120/277 voltage. Thus, the present power converter is designed to convert the power which would normally go to the fluorescent lamps, which is not standard 120/277 volt power, to a DC voltage (and wattage) that may be used to illuminate the LEDs. Those of skill in the art will also appreciate how the power converter may be built, constructed, and/or designed to accomplish this purpose.

It should be noted that, in other embodiments, the converter 136 may further be designed to adjust (dial up or down) the wattage. Specifically, when the converter receives the power from the ballast, the converter 136 may be designed to adjust the associated wattage, up or down, as desired, in order to ensure that the wattage is optimal for use with the LEDs. Those of skill in the art will appreciate how such “tailoring” of the wattage may be accomplished.

Leads 140 are used to connect the ballast 116 to the power converter 136. In many embodiments, the leads 140 will be the same as the leads 132. In other words, the leads 132 are disconnected from the sockets 120 and are instead connected to the converter 136. Of course, other embodiments may be designed in which the leads 140 are different from the leads 132. The ballast 116 is connected/wired to the power converter 136 such that when AC power is supplied to the ballast 116 (i.e., when the light switch is turned on), the AC power is not sent from the ballast 116 to the sockets 120. Rather, the AC power output from the ballast 116 is sent to the power converter 136. Those skilled in the art will understand and appreciate how the lighting fixture 100 may be wired/configured so that the AC power output from the ballast 116 is sent to the power converter 136.

When the AC power is sent to the power converter 136, the converter 136 will, of course, convert this AC (alternating current) power into DC (direct current) power. Accordingly, when the power exits the converter 136, the power will be direct current power.

One or more LEDs 144 are also part of the light fixture 100. The LEDs 144 are attached to the power converter 136 via one or more leads 150. Any type of LED or SSL device may be used as the LEDs 144, including LEDs of all levels of brightness, illumination, etc. The particular LED used will depend upon each particular application (and the lighting requirements required for each situation).

In some embodiments, the LEDs 144 may be positioned remote of the ballast tray cover 124 (such as in the wall, ceiling, floor, etc.). However, in the embodiment shown in FIG. 1, the LEDs 144 are positioned on and protrude through ballast tray cover 124. In some embodiments, the LEDs 144 will protrude through the ballast tray cover 124. In other embodiments, the LEDs 144 will be positioned on the ballast tray 112, on the cover 108, on an illuminating surface of the light fixture 100, or on any other portion of the fixture 100. U.S. Pat. No. 7,086,747 and U.S. patent application Ser. No. 11/435,945 disclose a type of lighting fixture in which a plurality of additional LEDs protrude through holes in the ballast cover. (Such prior patents/patent applications are expressly incorporated herein by reference.) Of course, the above-recited patent/patent application only indicate one way in which the LEDs 144 may be incorporated as part of the light fixture 100. Other embodiments may configure the LEDs differently and/or may add the LEDs to different locations or positions both inside and outside of the light fixture 100.

The LEDs 144 receive DC power from the power converter 136. Accordingly, after conversion, AC power is no longer provided by the ballast 116 to the lamps 104 when the light switch is turned on. (As such, turning the switch on does not illuminate the fluorescent lamps 104.) Rather, when the switch is turned on, AC power is output from the ballast 116 to the power converter 136. The power converter 136 converts this power to DC power and then this DC power is output from the power converter 136 to the LEDs 144 via the leads 150. This DC power is used to drive and illuminate the LEDs 144. Accordingly, after conversion, the lighting fixture 100 provides more efficient LED light rather than high voltage, less efficient fluorescent light. In other words, by adding the power converter 136 and making adjustments to the wiring, the light fixture 100 has been quickly and inexpensively converted from a fluorescent light to an LED light, without requiring the replacement of the entire light fixture and/or light system. Also, the owner is not required to replace the existing ballast(s) found in the lighting system.

It should be noted that the power converter 136 of the present embodiments may include an impedance matching circuit 170. Those skilled in the art will appreciate how to construct or design such a circuit. In some embodiments, this circuit 170 may include a capacitor 172 and/or an inductor 174. Of course, other circuits 170 may be designed that do not include a capacitor or an inductor. Because of the variability of different ballasts, this impedance matching circuit 170 can regulate the power to match the impedance, the ballast load and/or the current frequency associated with the ballast to ultimately result in high efficiency operation (and thus be more efficient to operate). (In some embodiments, the matching circuit 170 may actually comprise two separate circuits, one for impedance matching and one for current regulation, but in other embodiments, these two functions are combined into the same circuit 170).

In some embodiments, an additional step of adjusting the current levels of the fixture 100 may be required. Specifically, the power converter 136 (or other portion of the fixture 100) may include a dial 180 (or other adjustment device) that may be adjusted (such as by a screwdriver). This adjustment may operate to fine tune the power supplied by the power converter 136 by impedance matching (via the impedance matching circuit 170) the power converter 136 to the match the ballast output impedance to maximize the efficiency of power transfer from the ballast to the LED 144 and regulating the specified LED current. In other embodiments, this adjustment may be used to adjust or fine tune the current output (via the circuit 170 or other circuits). As each particular fluorescent light fixture (or fluorescent light manufacturer) may have different specifications, the user may adjust the current magnitude and/or phase to match each particular embodiment (or more particularly, to match the particular ballast that is driving the LED rod). This impedance match adjustment can be achieved by a varying reactance by many means; but vary the inductance by mechanical adjustment. Such adjustment may optimize the power usage and/or brightness of the light. In other embodiments, the adjustment prevents the ballast from “overdriving” the LEDs. In most fluorescent light fixtures, the output from the ballast is at high frequency and 600 volts. However, the ballast output impedance which typically consist of at least one inductor and one capacitor, Ballast and frequency will vary for each particular ballast, the user may adjust the converter output, as desired, using the adjustment mechanism.

As shown herein, the impedance matching circuit 170 may be added to the other embodiments described herein.

There are a variety of different applications and/or scenarios for converting or retrofitting fluorescent lights to LED lighting systems in accordance with the present disclosure. Specifically, one potential embodiment involves taking an existing fluorescent light fixture and/or fluorescent light system and retrofitting the light fixture(s) with an power converter to convert the fixture into an LED fixture. The steps involved in this retrofitting process may include the following:
1. Removing the fixture lens (i.e., the cover);
2. Removing the fluorescent lamps;
3. Removing the ballast tray cover;
4. Installing the power converter to the existing ballast tray and then connecting this converter to the ballast (such as by using the fluorescent output leads);
5. Installing and connecting the one or more LEDs (which may occur by installing LEDs into the light fixture, installing LEDs remote from the light fixture, or by simply replacing the ballast tray cover with a new ballast tray cover that already has the LEDs pre-positioned therein);
6. Optionally, installing and connecting additional LED devices external or remote from the light fixture; and
7. Reinstalling the fixture cover (lens).

The result of this installation method is that the fluorescent lamps have been removed and replaced. The resulting light fixture is now a fully functional LED fixture that has been obtained using the existing fluorescent light fixture and existing ballast technology. This is a relatively inexpensive conversion to LED lighting and would not require replacement of the existing fixtures.

As noted in the above-recited method, it is possible to install some or all of the LEDs remote from the ballast tray cover. It should be noted that positioning the LED devices remote from the ballast tray cover may increase the retrofit conversion cost as it may require additional wiring, additional steps in connecting the remote LEDs, additional steps in positioning the remote LEDs, and/or additional retrofitting steps.

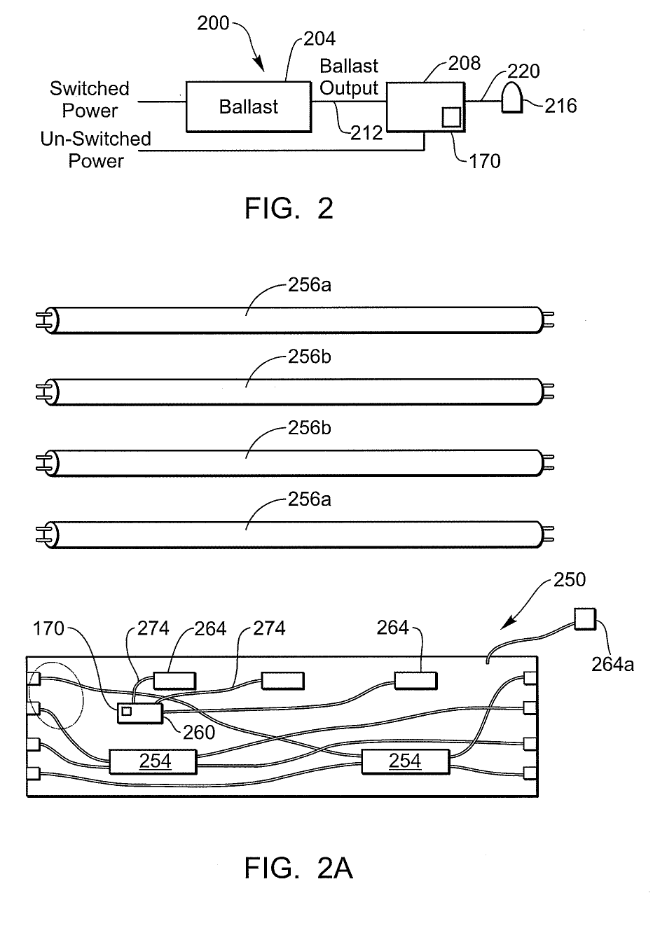

A second possible scenario for converting or retrofitting fluorescent lights to LED lighting systems uses conventional duel switching. (This embodiment is shown in detail in FIG. 2A). In 4-lamp and 3-lamp fluorescent fixtures, it is possible to switch the two outer lamps separately from the two or one inner lamps. FIG. 2A shows a 4 lamp fixture 250. This is designed by architects to provide a high and low light scenario in new and in many existing buildings. Thus, there are two ballasts (power supplies) in these fixtures. The first ballast 252, one which drives the outer fluorescent lamps 256a and the second ballast 254 drives the inner fluorescent lamps 256b. This dual switching makes it possible to leave the outer fluorescent lamps unchanged and then to utilize the second ballast 254 (power supply) to connect to the power converter 260, that would operate more efficient LED lights 264 (or even external LEDs 264a). (This connection between the conventer 260 and the LEDs is via leads 274). The switches for these two scenarios are already in place and this is a common arrangement in many new and existing buildings. This is an opportunity for retrofitting LEDs into classrooms, other commercial applications, etc.

The steps involved in this retrofitting process may include the following:
1. Removing the fixture lens (i.e., the cover);
2. Removing the inner fluorescent lamps;
3. Removing the ballast tray cover;
4. Installing the power converter in the ballast tray and then connecting this converter to one of the two ballasts (such as by using the fluorescent output leads);
5. Installing and connecting the one or more LEDs (which may occur by installing LEDs into the light fixture, installing LEDs remote from the light fixture, or by simply replacing the ballast tray cover with a new ballast tray cover that already has the LEDs pre-positioned therein);
6. Optionally, installing and connecting additional LED devices external or remote from the light fixture; and
7. Reinstalling the fixture cover (lens).

The result of this installation method is that part of the fluorescent lamps have been removed and replaced with LED lights and part of the fluorescent lamps have been left in place. The resulting light fixture is now a fully functional fluorescent fixture and a fully functional LED fixture. This arrangement will allow you to operate in four operating modes: 1) all light are turned off, 2) only fluorescent lights are turned on, 3) only LED lights are tuned on, and 4) is that both the fluorescent lights and the LED lights are turned on. As noted in the above-recited method, it is possible to install some or all of the LEDs remote from the ballast tray cover. It should be noted that positioning the LED devices remote from the ballast tray cover may increase the retrofit conversion cost as it may require additional wiring, additional steps in connecting the remote LEDs, additional steps in positioning the remote LEDs, and/or additional retrofitting steps.

Referring again to FIG. 1, it should be noted that the present embodiments regarding replacing fluorescent lights with LEDs are not limited solely to conventional ballasts and conventional fluorescent light technology. Rather, the present embodiments may be used with the so-called “multi-functional” ballasts. U.S. patent application Ser. No. 11/738,909 (hereinafter the “'909 application”) describes a multi-functional ballast. (This prior patent application is expressly incorporated herein by reference.) This multi-functional ballast has a switching circuit that switches between high voltage and low voltage. As explained in this patent application, this multi-functional ballast allows a system to be constructed that has both LEDs and fluorescent lights. When the multi-functional ballast operates a “high voltage,” the fluorescent lights will be illuminated (and the LEDs turned off) whereas when the multi-functional ballast operates at “low voltage,” the LEDs will be illuminated (and the fluorescent lights turned off).

The present embodiments regarding conversion of a fluorescent light system to an LED light system may also be used in conjunction with the multi-functional ballast described in the '909 application. Such conversion would mean that the '909 application would operate fully using LED technology. If such a conversion were made, the resulting light fixture would still include a multi-functional ballast that switched between high voltage and low voltage. The low voltage operation would illuminate the LEDs (in the manner described by the '909 application). However, if the conversion were made, a power converter would be added so that the fluorescent lights could be replaced by high output LEDs. In other words, the light fixture would have two separate sets of LEDs, namely a set of LEDs that would operate when the ballast is at high voltage and a set of LEDs that would operate when the ballast is at low voltage. In some embodiments, the operation at low voltage would involve low output LEDs whereas the operation at high voltage would illuminate high output LEDs (that have replaced the fluorescent lamps). For example, in FIG. 1, there is an external LED 144a that may be attached to the light fixture and may be powered by the converter, as described herein. This LED may be a part of a “first set” of LEDs that operate at the low voltage whereas the LEDs 144 may operate at the high voltage. (Of course, alternative embodiments may be designed in which the LEDs 144 operate at the low voltage and the LED 144a operates at the high voltage, as desired). The external LED 144 may be positioned on an outer surface of the light, on a wall, etc.

The third possible scenario uses the multi-functional ballast with both high output LEDs and low output LEDs, which provides significant advantages. For example, as the system involves exclusively LEDs, the fixture will be energy-efficient and will provide cost savings. Also, by having additional sets of LEDs, the user may adjust the levels of illumination based upon his/her own preference. In other words, if the user desires high levels of illumination, he or she may illuminate the high output LEDs, whereas if lower levels of lighting are desired, the lower output LEDs may be illuminated. Thus, the user could tailor the lighting needs depending on the particular application and his/her own preferences. Such lighting fixtures using the multi-functional ballast and high lumen and low lumen output LEDs may be particularly suitable for providing task/work lighting, class room lighting, lighting for computer labs, work stations, etc. As described in the '909 application, such systems may further be used for energy conservation and energy management planning (24-hour mandated lighting, stairwell lighting, hallway lighting, emergency lighting, etc.). However, because exclusively LEDs are used in the lighting system, further cost savings/energy savings may be enjoyed. Also, as explained in the '909 application, the lower output LEDs used with the multifunctional ballast may also provide emergency lighting for occasions when power is interrupted.

One method for converting/retro-fitting the multi-functional ballast to operate exclusively with LEDs will now be explained. The steps involved in this retrofitting process may include the following:
1. Obtaining or accessing a fluorescent light fixture that includes fluorescent lights and the multi-functional ballast;
2. Removing the cover (lens) found on fluorescent fixture;
3. Removing fluorescent lamps from the fixture;
4. Installing and connecting the power converter to the multi-functional ballast (by attaching the output leads from the multi-functional ballast to the converter rather than to the sockets);
5. Installing and connecting one or more high output LEDs (which may be accomplished by installing high output LEDs into the light fixture, installing high output LEDs remote from the light fixture, or by simply replacing the ballast tray cover with a new ballast tray cover that already has the high output LEDs positioned therein)
6. Connecting the high voltage LEDs to the power converter;
7. If not already installed, install the second set of LEDs (which may be positioned on the ballast tray cover or may be positioned remote of the light fixture);
8. If not already properly connected, connecting the second set of LEDs directly to the multi-functional ballast;
9. Optionally, installing and connecting additional high output or low output LED devices external or remote from the light fixture; and
10. Reinstalling the fixture cover (lens).

By using the above-recited method, the resulting light fixture will still have the capability to switch between high voltage and low voltage and will have two sets of LED lights. The set of LEDs will be a high output light whereas the second set of lights would be LEDs that operate at low output. (In some embodiments, the second set of LED lights would be low output LEDs capable of operating while the multi-functional ballast is at low voltage. However, any type of LED capable of operating while the multi-functional ballast is at low voltage may be used.) Thus, all of the advantages described in the '909 application for a lighting device that includes both high and low output lighting will be achieved. However, the present embodiments will have an additional advantage in that all of the lights in the device will be energy-efficient LEDs (rather than some of the lights being fluorescent lights). The user will be able to switch between these high output LEDs and low output LEDs depending upon his/her preference and the particular lighting needs for each situation. Thus, the present method provides a relatively inexpensive way to replace fluorescent lights and convert to full LED lighting, which would not require replacement of the existing fixtures.

Of course, the above-recited methods have been directed at retrofitting or converting existing fluorescent lights to LED lighting systems, those of skill in the art would appreciate that the present teachings could likewise be applied to constructing a new lighting fixture that includes LEDs rather than fluorescent lights. Thus, in new construction, the builder may design a functional lighting system that is patterned after a conventional fluorescent light system. However, instead of installing the fluorescent lamps into this system, the builder would instead install (in a manner described herein) a light device that has a power converter and LEDs. (The LEDs could be pre-fabricated as part of the light fixture). Accordingly, such a building owner would have, from the outset, a building that used LED light and would not have to worry about “retro-fitting” the fluorescent light fixture with an LED fixture.

Further, although the present embodiments have been described in conjunction with fluorescent light systems with T12 or T8 ballasts that are common in commercial/industrial applications, those of skill in the art will recognize that the present embodiments and teachings may be applied to any and all other types of fluorescent lights or fluorescent lighting systems as desired.

As described herein, the present embodiments relate to system and/or method for removing one or more fluorescent lamps from a fluorescent light fixture and then replacing such fluorescent lamps with LEDs. It should also be noted that any and/or all of the present embodiments may also be used with a battery “back-up” system. This battery back-up system may include one or more batteries that will provide power to illuminate the LEDs in the event of a power outage, thereby providing “emergency lighting” to the building occupants. The power converter is perfectly compatible for the battery backup concept and remains a viable alternative when ballasts are converted from AC to DC power using the power converter. Since the LEDs are low-voltage, the LEDs can easily provide sufficient power to illuminate the LEDs. The battery back-up system may also be designed such that during normal operation, the building's AC power supply operates to charge and/or recharge the batteries, thereby ensuring that the batteries have sufficient power to light the LEDs during an emergency. If a fluorescent light fixture does not have a battery back-up system, this type of battery back-up system can easily be installed when the fluorescent fixture is retrofit using the power converter. Accordingly, in some embodiments, the present methods may include the step of adding a battery back-up system as part of the retrofitting process. Those skilled in the art will understand how to implement, wire, design and/or construct a battery back-up system for use with the present lighting fixtures.

Another possible scenario and/or application that involves using the power converter may involve using the existing fluorescent sockets 120 (as shown in FIG. 1) for LED lights. (As explained above, these sockets 120 are sometimes called “tombstones”). Specifically, as detailed herein, the present embodiments relate to converting AC power to DC power using the existing ballast of a fluorescent fixture. Accordingly, the leads exiting the ballast are attached to the inlet of the power converter.

In some embodiments, it may be possible to connect outlet leads from the power converter to the sockets 120. In these embodiments, it would then be possible to utilize the existing fluorescent sockets to power LEDs. More particularly, LEDs may be installed on a conductive strip that is the same length as the fluorescent lamp. The strip containing the LEDs may be made of aluminum or other conductive materials. (Based on need and engineering design, the number of LEDs could be varied as needed.) As noted above, the strip may be the exact same length as the fluorescent lamps that formally were installed in these sockets 120. This LED strip or rod would then fit into the sockets 120, in the same manner that the previous fluorescent lamp fit into the sockets 120 (i.e., the strip or rod would have pins on the ends that fit into the sockets 120). When properly configured, the power converter alters the power from high-voltage to low-voltage power, which is then compatible with LEDs. Accordingly, the power that is supplied from the sockets 120 to the strip is DC power that is used to power the LEDs in the strip.

This constructing of a strip or rod having one or more LEDs may provide significant advantages. For example, this strip would provide an easy, simple, and convenient location for positioning the LEDs, thereby obviating the need for replacing the existing fixture and/or the room with new LED-fixtures. Rather, when this embodiment is used, the LEDs fit into the same location that was formerly occupied by the fluorescent lamps.

One method for converting/retro-fitting the fluorescent fixture with a strip of LEDs will now be explained. This method involves utilizing the sockets as the electrical contact point for the LEDs. The steps involved in this retrofitting process may include the following:

1. Removing the fixture lens (i.e., the cover);

2. Removing the fluorescent lamps;

3. Removing the ballast tray cover;

4. Install the power converter by taking the leads from the ballast, which formally powered the fluorescent lamps and attaching them to the inlet of the power converter, and then connecting the outlet leads from the power converter to the former fluorescent sockets, thereby making the sockets “LED sockets” that are ready to receive the LED light strip;

Install the strip containing the LEDs into the LED sockets (former fluorescent sockets); and

Re-installing the fixture lens (which is the last step in the installation process).

It is worth noting that the lighting strips (containing LEDs) could be used with any fluorescent fixture, whether new or old. LEDs can provide acceptable levels of brightness and illumination, and as such, the present embodiment provide of replacing some or all of the fluorescent fixtures without requiring the user to re-design and/or re-configure the design of the fixture. In other words, if a user prefers the design of an existing, older fluorescent light fixture, the present embodiment allows the user to convert this fixture into an LED fixture, without compromising the design, appearance, attractiveness and/or “charm” of the light fixture.

Referring now to FIG. 2, a schematic drawing illustrates a lighting system 200 is illustrated that incorporates a ballast 204 and an power converter 208 in accordance with the present embodiments. The ballast 204 may be any type of ballast that is known and/or conventionally used as part of a fluorescent light system. As is known in the art, the ballast 204 receives switched power (AC power) from the building's power supply. Those skilled in the art will appreciate that the ballast 204 is configured with the circuitry, wiring, and/or components necessary to convert this switched power into a “high voltage” power supply that is capable of driving/illuminating the fluorescent lamps.

As explained herein, when operation as a fluorescent light system, the output lead 212 from the ballast 204 would generally be connected to a socket that holds the fluorescent lamps. However, in the present embodiments, the output lead 212 is instead connected to the power converter 208. The power converter 208 is a device or component that is designed to adjust the high voltage power output from the ballast 204 into a power supply that is capable and designed for use with one or more LEDs 216. In other words, instead of using the high voltage power from the ballast 204 to drive fluorescent lamps, the power converter 208 converts the power output from the ballast into a power supply that is appropriate to drive/illuminate the LEDs 216. As discussed above, the voltage that is necessary to drive a fluorescent lamp is often much higher than is recommended for use with LEDs. Accordingly, in some embodiments, the power converter 208 may operate to reduce the voltage of the power output by ballast 204 to a low voltage power supply that is appropriate for LEDs. Of course, other adjustments/modifications of the power output by the ballast 204 may be accomplished by the power converter 208, as necessary, in order for this power to be used to properly and/or optimally illuminate the LEDs 216. One or more output leads 220 exiting the power converter 208 connect the power converter 208 to the LEDs 216.

It should be noted that the converter 208 may be composed of a variety of different circuitry, wiring, components, etc. depending upon the particular embodiment. In fact, those of skill in the art will understand that there are a variety of different ways and/or mechanisms for implementing the power converter 208, which depend, at least in part, in the particular application and the ballast 204 with which the power converter 208 is used. Thus, the circuitry, components, etc. for each particular embodiment of the power converter 208 may depend upon particular embodiment. Of course, those of skill in the art will appreciate how each particular embodiment of the power converter 208 will be constructed and/or the particular components, wiring, circuitry, etc. for each particular embodiment.

In the embodiment shown in FIG. 2, the power converter 208 is referred to as an “emergency power converter”. This name refers to the power converter 208 being connected to an un-switched power (DC power) source. This un-switched power source may be one or more batteries, as described above. Thus, in the event that the switched power from the building is no longer being received, the un-switched power (from the batteries) will be provided to the power converter 208 and then used to illuminate the LEDs 216. Such illumination of the LEDs 216 via the un-switched power may occur during a power outage, during an emergency, etc. Such provision of un-switched power to the power converter 208 means that the apparatus 200 may function as an “emergency” lighting system, i.e., a lighting system that will illuminate during an emergency to assist the occupants in exiting the building.

Although much of the previous discussion has been directed to “retrofitting”, it should also be noted that the present technology could also be used with “new” lighting fixtures. For example, a new lighting fixture may be designed to include a converter and/or the other components as taught herein. By modifying a new light fixture to include the converter, the overall design, size, appearance, look and/or configuration, of the light fixture does not need to be revamped. Yet at the same time, the new light fixture will incorporate the advantages of LEDs rather than fluorescent lamps. Thus, a new building and/or new light system could be constructed using the present embodiments and a power converter.

As explained herein, the present embodiments provide systems and methods that use an power converter in conjunction with a fluorescent lighting system. Specifically, the power converter is added to the light system so that power output from the ballast is directed to the converter rather than the sockets of the fluorescent light fixture. The power converter then converts this power, which is generally high voltage power used for driving a fluorescent lamp, into low voltage power designed for use with LEDs. The converted power is then output from the power converter and is used to power LEDs, thereby converting the fluorescent light system to an LED light system. Of course, further embodiments in the application relate to retrofitting existing fluorescent light systems to convert these fluorescent lights to LED systems using a power converter. Other embodiments may be designed in which new light fixtures are constructed that contain the power converter prior to installation into the building.

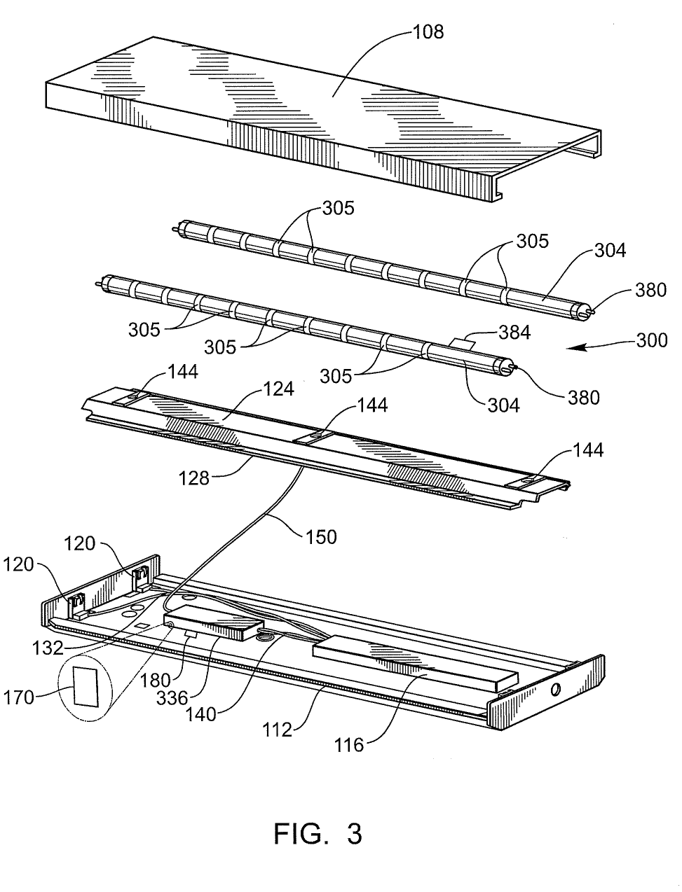

As shown in FIG. 3, an embodiment of a lighting system 300 is illustrated. The lighting system is similar to the lighting system 100 described above. In this embodiment, the power converter 336 may be positioned on the ballast tray 112 and then be connected to the sockets 120 already existing on the lighting fixture. In such embodiments, a “rod” 304 of LEDs 305 could then be inserted into the sockets. The rod 304 will have one or more LEDs 305 and will have a length that is equal to the length of the standard fluorescent lamp. The number of LEDs 305 will depend upon the design of the rod and the lumen/output requirements. Thus, the shape and/or design of the overall light fixture 300 will not change. Rather, the light fixture 300 will have the look and feel of a fluorescent light fixture, but instead of a fluorescent rod that illuminates, the rod 304 will have one or more LEDs that illuminate.

Further embodiments that use the power converter 336 may also be incorporated and used with a “rod” 304 or strip of LEDs 305. Again, the rod 304 of LEDs will be sized to fit into the conventional sockets 120 found on the fluorescent light fixture 300. The rod will have pins 380 or male engagers at each end that fit into the sockets 120. However, unlike the previous embodiment, the power converter 336 does not necessarily have to be located on the ballast tray 112 (or on another portion of the light fixture). In fact, embodiments may be constructed in which the power converter 336 does not need to be retro-fit or added to the light fixture itself. Rather, in these embodiments, the power converter 3360is positioned as part of the LED rod 304. In other embodiments, the power converter 336 is positioned on the LED rod 304 (such as on the underside of the rod, along the edge of the rod, on the interior of the rod, etc.). Any location on or within the rod may be used for the power converter 336, depending upon the particular embodiment.

Using the present embodiments, a user can simply replace the existing fluorescent lamp with a new LED-containing rod 304 (which has the converter built therein). Accordingly, all the user is required to do in converting the fluorescent light fixture to an LED light fixture is to remove the existing fluorescent lamps and replace these lamps with LED containing lamps that have the converter built therein. No re-wiring or connection of wires is required. Similarly, no installation process for the power converter is required. The retrofitting process is simple, easy, and may be accomplished by average homeowners (and not electricians, professionals, etc.) In some embodiments, no re-wiring or modification to the existing light fixture and/or electrical system will be required.

Those skilled in the art will understand the wiring, components, etc. that are necessary to construct an LED rod 304 that has the power converter 336 contained therein or built therein. In fact, those skilled in the art will appreciate that there are a variety of different ways that this may be embodied.

It should be noted that embodiments may be constructed that use LEDs 305, or rods 304 of LEDs, that produce a greater amount of lumens/output than a corresponding fluorescent lamp, but at the same time, require less power and/or are less expensive to operate.

It should be noted that the present embodiments provide for a method of installing a LED light system. The present embodiments also teach a method of converting a fluorescent light system into an LED lighting system. The steps in these methods can include:

Removing the fluorescent fixture cover (i.e., the lens 108);

Removing the fluorescent lamps from the fixture;

Installing an LED rod 304 into the fixture sockets 120 (the LED rod 304 including the power converter 336 and LEDs 305 positioned therein); and

Reinstall the fixture lens 108.

In some embodiments, an additional step of adjusting the current levels of the fixture may be required after the LED rod has been inserted into the socket. Specifically, the rod of LEDs may include a dial (or other adjustment device) that may be adjusted (such as by a screwdriver). This adjustment may operate to fine tune the power supplied by the Power converter by impedance matching the power converter to the match the ballast output impedance to maximize the efficiency of power transfer from the ballast to the LED and regulating the specified LED current. In other embodiments, this adjustment may be used to adjust or fine tune the current output. As each particular fluorescent light fixture (or fluorescent light manufacturer) may have different specifications, the user may adjust the current magnitude and/or phase to match each particular embodiment (or more particularly, to match the particular ballast that is driving the LED rod). This impedance match adjustment can be achieved by a varying reactance by many means; but vary the inductance by mechanical adjustement. Such adjustment may optimize the power usage and/or brightness of the light. In other embodiments, the adjustment prevents the ballast from “overdriving” the LEDs. In most fluorescent light fixtures, the output from the ballast is at high frequency and 600 volts. However, the ballast output impedance which typically consist of at least one inductor and one capacitor, Ballast and frequency will vary for each particular ballast, the user may adjust the converter output, as desired, using the adjustment mechanism.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. A lighting system comprising:
a ballast;
an power converter connected to the ballast; the power converter comprising an impedance matching circuit; and
one or more LEDs connected to the converter.

2. A lighting system as in claim 1 wherein the ballast is a conventional fluorescent light ballast.

3. A lighting system as in claim 1 wherein the system further comprises a ballast tray cover, wherein the LEDs are positioned on or protrude through a ballast tray cover.

4. A lighting system as in claim 1 wherein the light system was a fluorescent light system to which the power converter was retrofit, thereby converting the light system from a fluorescent light system.

5. A method for converting a fluorescent light fixture into an LED light fixture comprising:
accessing or obtaining a fluorescent light fixture, the fluorescent light fixture comprising one or more fluorescent lamps and a ballast;
removing the fluorescent lamps;
installing an power converter, the power converter comprising an impedance matching circuit;
installing LEDs to the fixture; and
connecting the LEDs to the converter.

6. A method as in claim 5 wherein the fluorescent light fixture further comprises a cover, wherein the first step in the method comprises removing the cover from the fluorescent light fixture and the last step in the method comprises reinstalling the cover to the fixture.

7. A method as in claim 5 wherein the fluorescent light fixture further comprises a ballast tray cover, wherein the method includes the step of removing the ballast tray cover.

8. A method as in claim 5 wherein the fluorescent light fixture further comprises a ballast tray, wherein the power converter is installed into to the ballast tray, wherein the is connected to the ballast via one or more leads.

9. A method as in claim 5 further comprising the step of optionally installing and connecting additional LEDs external from the light fixture.

10. A method as in claim 5 wherein the ballast is a multi-functional ballast and further comprising the step of connecting the LEDs to the converter via output leads from the ballast.

11. A method as in claim 5 wherein the fixture comprises one or more first LEDs and one or more second LEDs.

12. A method for converting a fluorescent light fixture to include LEDs lights and fluorescent lamps, the method comprising:
accessing or obtaining a fluorescent light fixture, the fluorescent light fixture comprising three or more fluorescent lamps and two ballasts, wherein the first ballast is connected to the outer two fluorescent lamps and the second ballast is connected to the inner lamps, removing the inner fluorescent lamps;
installing an power converter, the power converter comprising an impedance matching circuit;
installing LEDs to the fixture in place of the inner fluorescent lamps and connecting the LEDs to the converter via output leads from the ballast; and
connecting the LEDs to the converter.

13. A method as in claim 12 wherein the fluorescent light fixture further comprises a cover, wherein the first step in the method comprises removing the cover from the fluorescent light fixture and the last step in the method comprises reinstalling the cover to the fixture.

14. A method as in claim 12 further comprising the step of optionally installing and connecting additional LEDs external or remote from the light fixture.

15. A method for converting a fluorescent light fixture to include LEDs lights, the method comprising:
accessing or obtaining a fluorescent light fixture, the fluorescent light fixture comprising one or more fluorescent lamps and a ballast, wherein the fluorescent lights fit into sockets;
removing the fluorescent lamps; and
installing an LED rod into the fixture sockets, the LED rod including the power converter, wherein the power converter comprises an impedance matching circuit;.

16. A method as in claim 15 wherein the fluorescent light fixture further comprises a cover, wherein the first step in the method comprises removing the cover from the fluorescent light fixture and the last step in the method comprises reinstalling the cover to the fixture.

17. A method as in claim 15 wherein the fluorescent light fixture further comprises a ballast tray cover, wherein the method includes the step of removing the ballast tray cover.

18. A method as in claim 15 further comprising the step of installing a power converter by taking the leads from the ballast, which formally powered the fluorescent lamps and attaching them to the inlet of the power converter, and then connecting the outlet leads from the power converter to the former fluorescent sockets, the power converter comprising an impedance matching circuit.
